(19) United States
(12) Patent Application Publication
(10) Pub. No.: US 2011/0023308 A1
(43) Pub. Date: Feb. 3, 2011

(54) Folding utility knife

(76) Inventor: Qiu Jian Ping, Hangzhou (CN)

Correspondence Address: COLLARD & ROE, P.C., 1077 NORTHERN BOULEVARD, ROSLYN, NY, 11576, US

(21) Appl. No.: 12/925,011

(22) Filed: Oct. 12, 2010

Related U.S. Application Data
(63) Continuation of application No. 12/454,342, filed on May 15, 2009.
Application No. 12/454,342 is a continuation of application No. 11/800,684, filed on May 7, 2007, now abandoned.
Application No. 11/800,684 is a continuation of application No. 10/909,449, filed on Aug. 2, 2004, now abandoned.

(30) Foreign Application Priority Data
Mar. 19, 2004 (CN) 2004-20008854.6

(51) Int. Cl. B26B 3/06

(52) U.S. Cl. 30/161

(57) ABSTRACT

A utility knife having a handle and a blade holder which is pivotally mounted on the handle for movement from an unfolded position to a folded position. The handle has a space adapted to receive the blade holder when the blade holder is in its folded position. The blade holder includes a main wall and guard wall mounted together and adapted to receive a blade therebetween and a locking pivotally mounted on the blade holder to lock the blade in place.

### BACKGROUND

This application is an improvement over U.S. patent application Ser. No. 10/437,089 filed May 13, 2003 and 10/570,134 filed Dec. 31, 2003, the contents of which are incorporated herein by reference.

The present invention relates to a utility knife and more particularly to a folding utility knife in which the blade may be folded into the handle when the knife is not in use.

Utility knives have been used for a number of years. Some of the utility knives in use have blades that are mounted on a blade holder which is foldable within a handle when the knife is not in use. However, some of these utility knives have many movable parts which makes them difficult to use and expensive to manufacture. In addition, in some of these utility knives replacement of the blade is a complicated operation any may require special tools.

### OBJECTS

The present invention overcomes these problems and has for one its objects the provision of an improved utility knife in which the blade holder may be easily folded into a handle.

Another object of the present invention is the provision of an improved utility knife in which the blade is held securely on the utility knife.

Another object of the present invention is the provision of an improved utility knife in which improved means are provided for replacing the blade on the utility knife.

Another object of present invention is the provision of an improved utility knife which is simple to use and inexpensive to manufacture and maintain.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a perspective view of a utility knife made in accordance with the present invention.

FIG. 2 is a top plan view thereof.

FIG. 3 is a sectional view taken along the line 3-3 of FIG. 2.

FIG. 4 is a sectional view similar to FIG. 3 showing the utility knife in a partially folded position.

FIG. 5 is a sectional view similar to FIG. 3 showing the utility knife in a fully folded position.

FIG. 6 is a sectional view taken along lines 6-6 of FIG. 2.

FIG. 7 is a sectional view taken along line 7-7 of FIG. 2.

FIG. 8 is a sectional view similar to FIG. 6 showing the blade being removed.

FIG. 8A shows a variation of FIG. 8.

FIG. 9 is a sectional view taken along line 9-9 of FIG. 8.

FIG. 10 is a plan view of another side of the folding utility knife of the present invention.

FIG. 11 is a perspective view of another embodiment of the present invention.

FIG. 12 is a top plan view thereof.

FIG. 13 is a sectional view taken along the line 13-13 of FIG. 12.

FIG. 14 is a sectional view similar to FIG. 13 showing the utility knife in a partially folded position.

FIG. 15 is a sectional view similar to FIG. 13 showing the utility knife in a fully folded position.

FIG. 16 is a sectional view taken along lines 16-16 of FIG. 12.

FIG. 17 is a sectional view taken along line 17-17 of FIG. 12.

FIG. 18 is a sectional view similar to FIG. 17 showing the blade being removed.

FIG. 19 is a sectional view taken along line 19-19 of FIG. 18.

FIG. 20 is a plan view of another side of the folding utility knife of the present invention.

### DESCRIPTION

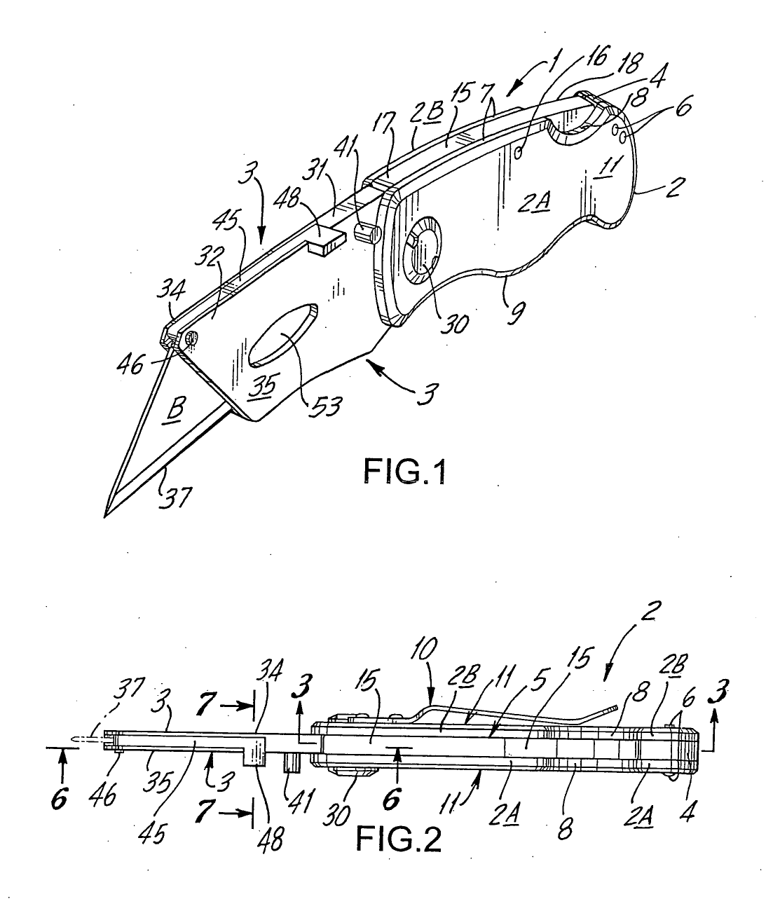

Referring to the drawings, and more particularly to the embodiment of the invention shown in FIGS. 1 to 10, the utility knife 1 of the present invention comprises a handle 2 and a blade holder 3.

The handle 2 comprises a pair of handle halves 2A and 2B each having an outer side wall 11, an upper edge 7 and a lower edge 9. A rear spacer 4 is provided between the handle halves 2A and 2B to maintain the handle halves 2A and 2B separated and to create a space 5 between handle halves 2A and 2B. The spacer 4 and the handle halves 2A and 2B may be held together by fasteners 6 which pass through the spacer 4 and the handle halves 2A and 2B in order to hold them together. The upper edge 7 of the handle halves 2A and 2B (i.e. the entire handle 2) has a finger notch 8 and the lower edge 9 of the handle halves 2A and 2B (i.e. the entire handle 2) may be undulated in order to permit the user's fingers to grip the handle 2. If desired, a clip 10 may be mounted on a side wall 11 of the handle halves 2A and/or 2B to permit the utility knife 1 to be fastened onto the user's belt or some other convenient place.

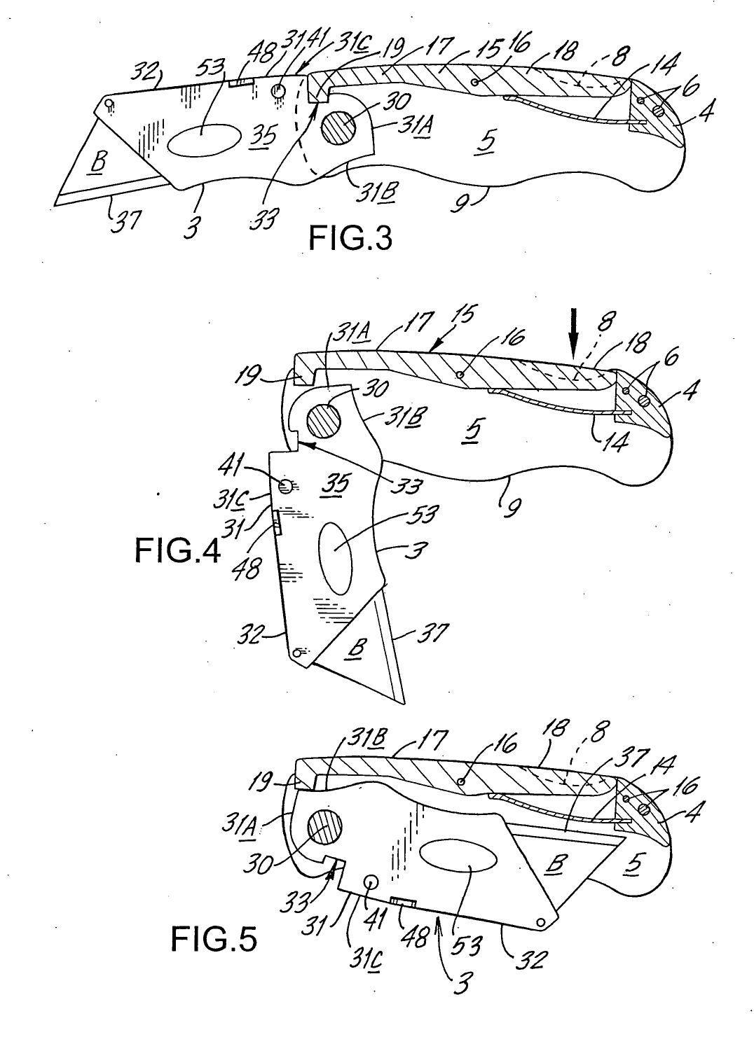

Interposed between the handle halves at 2A and 2B and along the upper edges 7 of the handle halves 2A and 2B there is provided a lock lever assembly 15 (FIGS. 3 to 5) which is pivotally mounted between the handle halves 2A and 2B on a pivot pin 16 which extends through the two handle halves 2A and 2B and the lock lever assembly 15. The lock lever assembly 15 is preferably a two arm lever having front and rear arms 17 and 18, respectively. The front arm 17 is provided with a downwardly extending lock finger 19. Below the rear arm 18 of the lock lever assembly 15 there is provided a spring 14 which normally bears against the bottom edge of the rear arm 18 to force the rear arm 18 upwardly and the front arm 17 downwardly around the pivot 16 so that rear arm 18 protrudes above the notch 8. It will be seen that when the rear arm 18 of the lock lever assembly 15 is pressed down manually through the notch 8 against the action of spring 14, the front arm 17 will be raised.

The blade holder 3 of the present invention comprises a rear end 31 and a front end 32 which are preferably one piece and integral with each other.

The rear end 31 of the blade holder 3 has rear edge 31A, bottom edge 31B and upper edge 31C. The blade holder 3 is pivotally mounted in the space 5 between handle halves 2A and 2B on a pivot pin 30. A finger knob 41 may be provided on the rear end 31 to facilitate the pivotal movement of the blade holder 3 relative to the handle 2. The upper edge 31C of the rear end 31 has a lock groove 33 into which the downwardly extending lock finger 19 of the lock assembly 15 is adapted to enter when the blade holder 3 is in its extended or unfolded position.

The blade holder 3 comprises a thin main wall 34 and a thin guard wall 35 which are held together by any well known means such as by welding them together or by fastening them together with suitable fasteners. If desired they may be made of one piece and integral with each other. The opposed inner portions of walls 34 and 35 adjacent the upper edge 36 are thinner than the thickness of the other portions of the walls 34 and 35 to form a groove 50 therebetween. The groove 50 has a downwardly extending clearance area 51 communicating therewith. The walls 34 and 35 have an elongated slit 52 formed therein which is adapted to receive and hold a blade B therein between walls 34 and 35. The blade B preferably has a lower cutting edge 37 and spaced notches 38 in its upper edge 39. The blade B is adapted to slide in and out of the slit 52 between the walls 34 and 35. Openings 53 may be provided in the walls 34 and 35 to permit the user to assist in coaxing the blade B in and out of slit 52.

A blade lock arm 45 is pivotally mounted within the groove 50 on a pivot pin 46 for pivotal movement in and out of the groove 50. Preferably, the pivot pin 46 is located at the front end 32 of the blade holder 31 and the blade lock arm 45 is pivoted on its front end 45F. However, the pivot pin 46 may be located at the rear end 31, if desired, in which event the blade lock arm 45 would be pivoted on its rear end 45R. The blade lock arm 45 has a downwardly extending blade finger 47 and a finger tab 48 extending laterally therefrom. When the blade lock arm 45 is pivoted downwardly around pivot 46, it will sit in the groove 50 and its blade finger 47 will enter into one of the upper notches 38 on blade B in order to lock the blade B in place. The downwardly extending clearance area 51 in the groove 50 will receive and accommodate the outer edges of the blade finger 47 when it is in its downward position. When it is desired to remove and replace the blade B, the blade lock arm 45 is pivoted upwardly by means of its finger tab 48 to move it out of the groove 50 and to move the blade finger 47 out of the blade notch 38 to release the blade B and permit it to be slid out of the slit 52. It will be understood that rather than a single blade finger 47, as shown, it is within the purview of the present invention to have a plurality of blade fingers 47 to enter the notches 38 in the blade.

FIG. 8A discloses a variation in which a compression spring means 49 will hold the blade lock arm 45 down within the groove 50 with its blade finger 47 entered in the upper blade notch 38. When it is desired to remove the blade B, the blade lock area 45 is raised out of the groove 50 against the tension of the spring 49 to release the blade B.

In operation of the utility knife shown in the embodiment of FIGS. 1 to 10, the utility knife 1 is placed in its operative unfolded position with the blade holder 3 unfolded and ready to be used. The blade B is held in the slit 52 by the blade finger 47 of the blade lock arm 45 (which is in its lower position) extending into a notch 38 in the top edge 39 of the blade B. The lock finger 19 of the front arm 17 of the lock lever assembly 15 is in its lower position (because of the pressure of spring 14 on rear arm 18) and is positioned in the groove 33 in the blade holder 3 in order to hold the blade holder 3 in its unfolded position. The rear arm 18 of the lock lever assembly 15 is in its raised position and protrudes above the finger notch 8 at the top edge 7 of the handle 2.

When it is desired to place the utility knife 1 into its folded inoperative position, the rear arm 18 of the lock lever assembly 15 is pressed down manually through the notch 8 against the bias of the spring 14. This causes the front arm 17 of the lock lever assembly 15 to be raised thereby moving the lock finger 19 out of the groove 33 to release the blade holder 3 and permit it to pivot downwardly around the pivot pin 30 (FIG. 4). This may be accomplished by pushing down on the finger knob 41. The blade holder 3 is then pivoted down completely into the space 5 between the handle halves 2A and 2B (FIG. 5). When pressure on rear arm 18 is released, the spring 14 moves the rear arm 18 back to its original raised position by the tension of the spring 14. This causes the lock finger 19 to bear against the button edge 31 B of the blade holder 3 thereby holding the blade holder 3 in its folded position.

When it is desired to use the blade B, the reverse procedure is followed. The blade holder 3 is pivoted in the opposite direction. It may be desirable for the rear arm 18 of the lock lever assembly 5 to again be depressed manually to assist in unfolding the blade holder 3. The blade holder 3 is continued to be rotated counter-clockwise (as seen in FIG. 4) until the lock finger 19 of the front arm 17 enters into the groove 33 in the rear end 31 of the blade holder 3 in order to hold the blade holder 3 in its extended position.

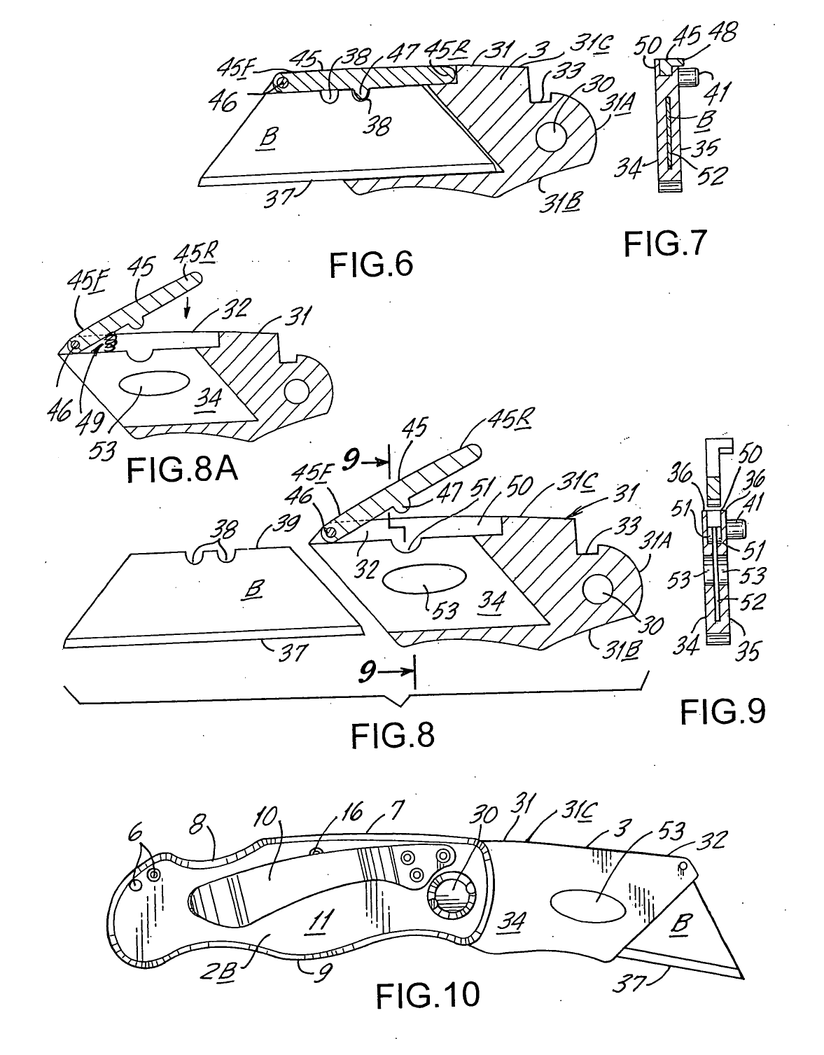

When it is desired to replace a blade B, the blade holder 3 is placed in its unfolded position (as shown in FIG. 6) and the blade lock arm 45 is lifted upwardly around pivot 46 out of the groove by means of finger tab 48 thereby moving the blade finger 47 out of the notch 38 in the upper blade edge 39 of the blade B to release the blade B. In the FIG. 8A variation this is done against the tension of the spring 49. The blade B can then be moved out of the blade holder 3 through slit 52 and a new blade B can be placed therein through the slit 52. The blade lock arm 45 is then lowered back into the groove 50 (in the FIG. 8A variation by spring 49) to move the blade finger 47 into the notch 38 in the blade B to lock the blade B in place.

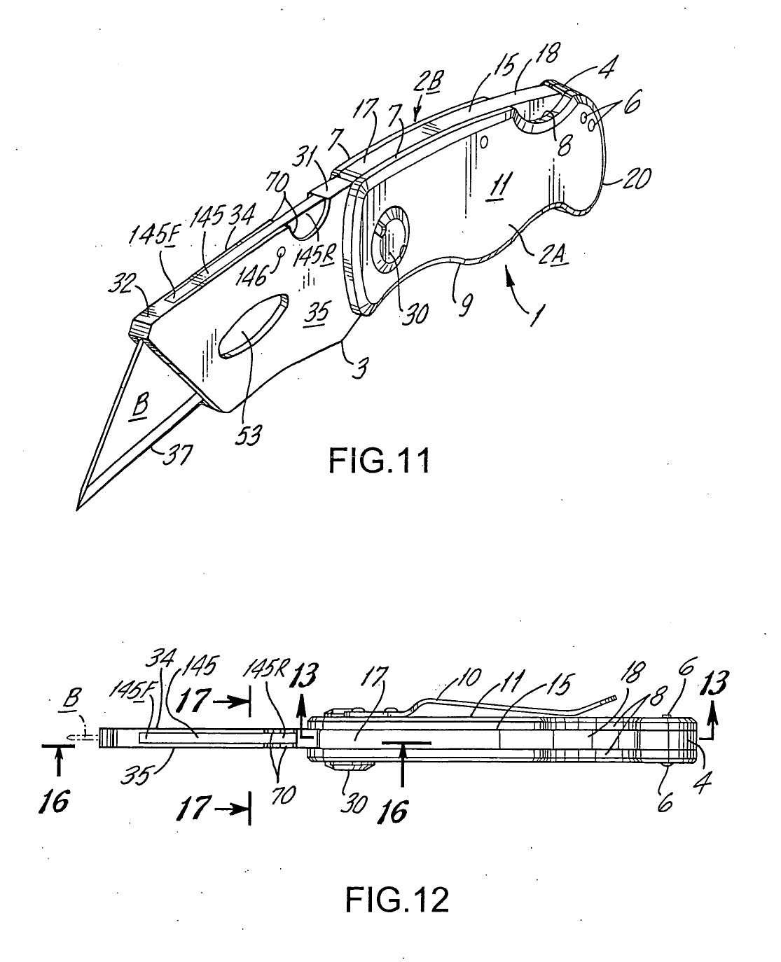

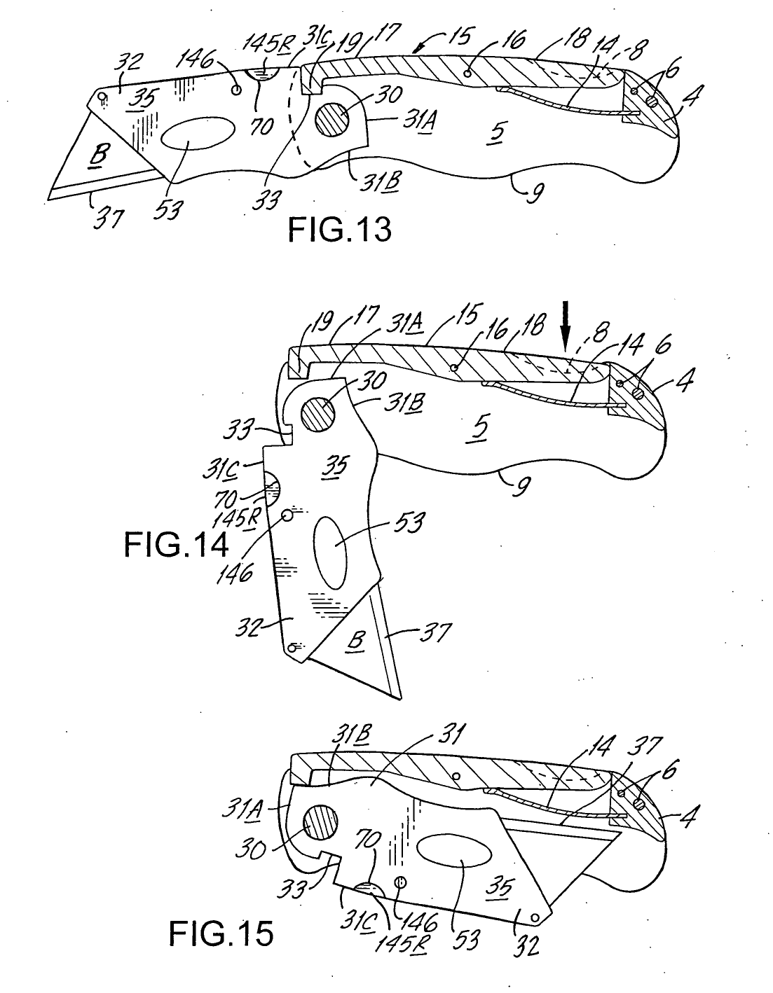

Referring now to the embodiment of the invention shown in FIGS. 11 to 20, structures in this embodiment which are the same as structures in the FIGS. 1 to 10 embodiment will be identified by the reference numerals.

The utility knife 1 shown in the FIGS. 11 to 20 embodiment comprises a handle 2 and a blade holder 3. The handle 2 comprises a pair of handle halves 2A and 2B each having an outer side wall 11, an upper edge 7 and a lower edge 9. A rear spacer 4 is provided between the handle halves 2A and 2B to maintain the handle halves 2A and 2B separated and to create a space 5 between handle halves 2A and 2B. The spacer 4 and the handle halves 2A and 2B may be held together by fasteners 6 which pass through the spacer 4 and the handle halves 2A and 2B in order to hold them together. The upper edge 7 of the handle halves 2A and 2B (i.e. the entire handle 2) has a finger notch 8 and the lower edge 9 of the handle halves 2A and 2B (i.e. the entire handle 2) may be undulated in order to permit the user's fingers to grip the handle 2. If desired, a clip 10 may be mounted on a side wall 11 of the handle halves 2A and/or 2B to permit the utility knife 1 to be fastened onto the user's belt or some other convenient place.

Interposed between the handle halves at 2A and 2B and along the upper edges 7 of the handle halves 2A and 2B there is provided a lock lever assembly 15 (FIGS. 3 to 5) which is pivotally mounted between the handle halves 2A and 2B on a pivot pin 16 which extends through the two handle halves 2A and 2B and the lock lever assembly 15. The lock lever assembly 15 is preferably a two arm lever having front and rear arms 17 and 18, respectively. The front arm 17 is provided with a downwardly extending lock finger 19. Below the rear arm 18 of the lock lever assembly 15 there is provided a spring 14 which normally bears against the bottom edge of the rear arm 18 to force the rear arm 18 upwardly and the front arm 17 downwardly around pivot 16 so that rear arm 18 protrudes above the notch 8. I will be seen that when the rear arm 18 of the lock lever assembly 15 is pressed downwardly through the notch 8 action of spring 14, the front arm 17 will be raised.

The blade holder 3 of the present invention comprises a rear end 31 and a front end 32 which are preferably one piece and integral with each other.

The rear end 31 of the blade holder 3 has rear edge 31A, bottom edge 31B and upper edge 31C. The blade holder 3 is pivotally mounted in the space 5 between handle halves 2A and 2B on a pivot pin 30. The upper edge 31C of the rear end 31 has a lock groove 33 into which the downwardly extending lock finger 19 of the lock assembly 15 is adapted to enter when the blade holder 3 is in its extended or unfolded position.

The blade holder 3 comprises a thin main wall 34 and a thin guard wall 35 which are held together by any well known means such as by welding them together or by fastening them together with suitable fastening means. If desired they may be made of one piece and integral with each other. The opposed inner portions of walls 34 and 35 adjacent the upper edge 36 are internally thinner than the thickness of the other portions of the walls 34 and 35 to form a groove 50 therebetween. The groove 50 has a downwardly extending clearance area 51. The walls 34-35 have a finger notch 70 adjacent rear end 31 of the blade holder 3. The walls 34 and 35 have an elongated slit 52 formed therein which is adapted to receive and hold a blade B therein between the walls 34 and 35. The blade B preferably has a lower cutting edge 37 and spaced notches 38 in its upper edge 39. The blade B is adapted to slide in and out of the slit 52 between the walls 34-35. Openings 53 may be provided in the walls 34-35 to permit the user to assist in coaxing the blade B in and out of slit 52.

A blade lock arm 145 is pivotally mounted within the groove 50 on a pivot pin 146. Preferably the pivot pin 146 is located at the rear end 31 of the blade holder 31, but may be located at the front end 32, if desired. The blade lock arm 145 is preferably a two arm lever having front and rear arm 145F and 145R, respectively. The front arm 145F is provided with a pair of downwardly extending blade fingers 147, although a single blade lock finger 17 (or more than two if blade B has more than two upper edge notches 38) may be used, if desired. Below the rear arm 145R of the blade lock arm 145 there is provided a spring 160 which normally bears against the bottom of the rear arm 145R to force the rear arm 145R upwardly and the front arm 145F downwardly around the pivot 146 so that rear arm 145R protrudes above the finger notch 70. It will thus be seen that when the rear arm 145R of the lock blade arm 145 is pressed down manually through the finger notch 70 against the action of spring 160, the front arm 145F will be raised. When the arm 145 is pivoted downwardly around pivot 146 under tension from the spring 160 it sits in the groove 50 and its blade fingers 147 on the front arm 145F will enter into the upper notches 38 on blade B in order to lock the blade B in place. The downwardly extending clearance areas 51 in the groove 50 will receive and accommodate the outer edges of the blade fingers 147 when they are in their downward position. When it is desired to remove and replace the blade B, the rear arm 145R is pivoted upwardly by applying manual pressure to the rear arm 145R through finger notch 70 to cause the front arm 145F, of the blade lock arm 145 to move out of the groove 50 and to move the blade fingers 147 out of the notches 38 to release the blade B and permit it to be slid out of the slit 52.

In operation of the utility knife, shown in the embodiment of FIGS. 1 to 10, the utility knife 1 is placed in its operative unfolded position with the blade holder 3 unfolded and ready to be used. The blade B is held in the slit 52 by the blade finger 47 of the blade lock arm 45 (which is in its lower position) extending into a notch 38 in the top edge 39 of the blade B. The lock finger 19 of the front arm 17 of the lock lever assembly 15 is in its lower position (because of the pressure of spring 14 on rear arm 18) and is positioned in the groove 33 in the blade holder 3 in order to hold the blade holder 3 in its unfolded position. The rear arm 18 of the lock lever assembly 15 is in its raised position and protrudes above the finger notch 8 at the top edge 7 of the handle 2.

When it is desired to place the utility knife 1 into its folded inoperative position, the rear arm 18 of the lock lever assembly 15 is pressed down manually through the finger notch 8 against the bias of the spring 14. This causes the front arm 17 of the lock lever assembly 15 to be raised thereby moving the lock finger 19 out of the groove 33 to release the blade holder 3 and permit it to pivot downwardly around the pivot pin 30 (FIG. 14). The blade holder 3 is then pivoted down completely into the space 5 between the handle halves 2A and 2B (FIG. 15). When pressure on rear arm 18 is released, the spring 14 moves the rear arm 18 back to its original raised position by the tension of the spring 14. This causes the lock finger 19 to bear against the bottom edge 31 B of the blade holder 3 thereby holding the blade holder 3 in its folded position.

When it is desired to use the blade B, the reverse procedure is followed. The blade holder 3 is pivoted in the opposite direction. It may be desirable for the rear arm 18 of the lock lever assembly 5 to again be depressed manually to assist in unfolding the blade holder 3. The blade holder 3 is continued to be rotated counter-clockwise (as seen in FIG. 14) until the lock finger 19 of the front arm 17 enters into the groove 33 in the rear end 31 of the blade holder 3 in order to hold the blade holder 3 in its extended position.

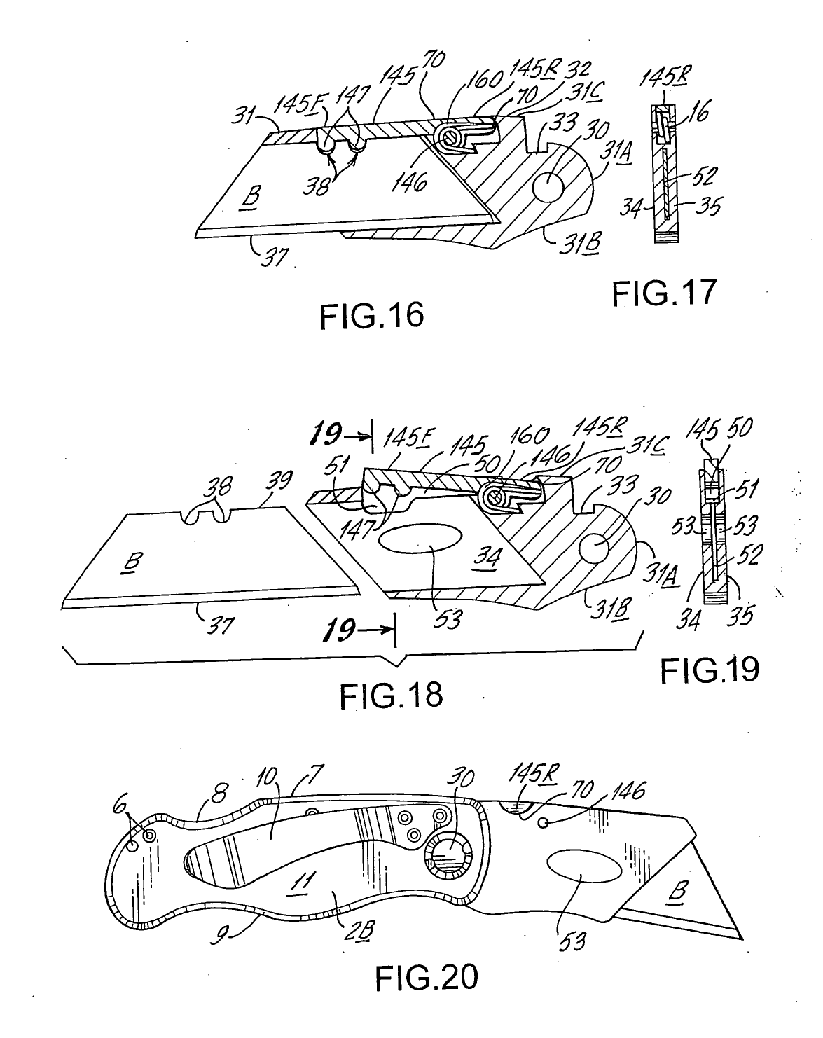

When it is desired to replace a blade B, the blade holder 3 is placed in its unfolded position (as shown in FIG. 16) and the blade lock arm 145 has its front arm 145F lifted upwardly around pivot 146 by applying pressure to the rear arm 145R through finger notch 70 thereby moving the blade lock arm 145 out of the groove 50 and moving the blade fingers 147 out of the notches 38 in the upper blade edge 39 to release the blade B. The blade B can then be moved out of the blade holder 3 through slit 52 and a new blade B can be placed therein through the slit 52. The blade lock arm 145 is then lowered by releasing downward pressure on the rear arm 145R through finger notch 70 to lower the blade lock arm 145 back into its groove 50 under tension of spring 160 and to move the blade fingers 147 into the notches 38 in the blade B to lock the blade B in place.

It will be seen that the present invention provides a utility knife in which the blade holder may be easily folded into a handle in which improved means are provided for securing the blade on the utility knife and for replacing the blade on the knife and which is simple to use and inexpensive to manufacture and maintain.

As many and varied modifications of the subject matter of this invention will become apparent to those skilled in the art from the detailed description given hereinabove, it will be understood that the present invention is limited only as provided in the claims appended hereto.

1 to 24. (canceled)

25. A utility knife comprising a handle and a blade holder, said blade holder being pivotally mounted on said handle for movement from an unfolded position to a folded position, said blade holder comprising a substantially flat elongated main wall and a substantially flat elongated guard wall mounted together in parallel relationship to each other, a blade removably mounted between said walls, said walls having a space therebetween to removably receive said blade therebetween, said space being substantially parallel to said walls, a blade lock lever for locking a blade between said walls, said blade lock lever being pivotally mounted and movable relative to the walls from an upper blade locking position to a lower blade unlocking position, said blade lock lever having a thin body and a depending blade lock finger, said blade lock finger being substantially parallel to said walls and said blade lock lever being moveable in a direction parallel to said walls, said blade lock lever comprising an arm, said blade lock finger extending from said arm, a spring operatively associated with said arm to bias the blade lock lever to said lower blade locking position, said handle comprising a pair of handle walls having a space therebetween for receiving at least a portion of said blade holder when the blade holder is in its folded position, said space being parallel to said walls, said handle having a pivoted handle lock lever assembly comprising a front arm, a rear arm and a handle lock finger extending from its front arm, said blade holder having a groove therein adapted to receive said handle lock finger when the blade holder is in its unfolded position, a spring mounted beneath the rear arm of the lock handle lever assembly to bias the rear arm upwardly and to bias the front arm downwardly to cause the handle lock finger to enter said groove, whereby depressing the rear arm against the bias of the spring will cause the front arm to rise and the handle lock finger to move out of the groove permitting the blade holder to pivot relative to the handle form an unfolded position to a folded position.

26. A utility knife as set forth in claim 25 wherein said blade lock finger is adapted to enter a notch in a blade to hold the blade in place when the blade lock lever is in said blade locking position.

27. A utility knife as set forth in claim 26 wherein said blade holder comprises a rear end and a front end, said front end comprising said guard wall and said main wall with said blade removably mounted thereon, said rear end being pivotally mounted to said handle.

28. A utility knife comprising a handle and a blade holder, said blade holder being pivotally mounted on said handle for movement from an unfolded position to a folded position, said blade holder comprising a main wall and a guard wall mounted together, a blade removably mounted between said walls, said walls having a space therebetween to removably receive said blade therebetween, a blade lock lever mounted on said blade holder and pivotally movable relative to the walls from a blade locking position to a blade unlocking position, said blade lock lever having a blade lock finger extending therefrom and adapted to enter a notch on the blade to removably hold the blade on said blade holder when the lock lever is in said blade locking position, said handle comprising a pair of handle walls having a space therebetween for receiving at least a portion of said blade holder when the blade holder is in its folded position, said handle having a pivoted handle lock lever assembly comprising a handle arm and a handle lock finger extending from said handle arm, said blade holder having a groove therein adapted to receive said handle lock finger when the blade holder is in its unfolded position, a spring operatively associated with said handle arm to bias the handle arm to a position to cause the handle lock finger to enter said groove.

29. A utility knife as set forth in claim 28 wherein said blade holder comprises a rear end and a front end, said front end comprising said guard wall and said main wall with said blade removably mounted therein said rear end being pivotally mounted to said handle.
